(19) United States
(12) Patent Application Publication
(10) Pub. No.: US 2009/0216781 A1
(43) Pub. Date: Aug. 27, 2009

(54) Technique for Dynamic Creation of a User Catalog for a Storage System

(76) Inventors: Philip R. Chauvet, Tucson, AZ (US); David C. Reed, Tucson, AZ (US); Michael R. Scott, Tucson, AZ (US); Max D. Smith, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 12/036,858

(22) Filed: Feb. 25, 2008

(51) Int. Cl. G06F 17/30

(52) U.S. Cl. 707/100; 707/E17.005

(57) ABSTRACT

A technique for operating a storage system includes determining, based on a response (e.g., return and reason codes from catalog services) from a storage operating system, that a desired user catalog is unavailable for storage of a new dataset. A new user catalog is then dynamically created, when the desired user catalog is unavailable. An alias entry in a master catalog is then updated to point to the new user catalog, when the desired user catalog is unavailable.

### BACKGROUND

1. Field

This disclosure relates generally to a storage system and, more specifically to a technique for dynamic creation of a user catalog for a storage system.

2. Related Art

In a typical storage system, a hierarchy of structures is used to manage hard disk drive (HDD) storage. Typically, each individual HDD (generally referred to as a physical volume (PV)) is assigned a name. In at least one storage system, each PV in use belongs to a volume group (VG) and all of the PVs in a volume group are divided into physical partitions (PPs). In this storage system, each PV is divided into regions for space-allocation purposes. The number of physical partitions in each region has generally varied, depending on a total capacity of the HDD. Within each VG, one or more logical volumes (LVs) have usually been defined. In general, LVs are groups of information located on PVs. Data on LVs appears to be contiguous to the user, but can be discontiguous on a PV. This allows file systems, paging space, and other LVs to be resized or relocated, to span multiple PVs, and to have their content replicated for greater flexibility and availability in the storage of data.

Each LV includes one or more logical partitions (LPs), which each correspond to at least one PP. LVs can usually serve a number of purposes, such as paging, but each LV usually serves a single purpose. An LV may contain a single journaled file system (JFS or JFS2), with each JFS including a pool of page-size (e.g., 4 kB) blocks. After installation, a typical storage system has one VG (the root VG), which includes a base set of LVs that are required to start the system and any other LVs specified via an installation script. PVs connected to the storage system can be added to a VG (using, for example, an extendvg command). In general, a PV can be added either to the rootvg VG or to another VG (defined using, for example, the mkvg command). LVs can be tailored using, for example, commands, a menu-driven system management interface tool (SMIT), or a web-based system manager. Today, administrators of storage systems are challenged to improve performance and utilization of available direct access storage devices (DASDs), e.g., HDDs arranged in a redundant array of inexpensive disks (RAID) configuration. While administrators of storage systems have been able to initially choose LVs where groups of DASD datasets are stored, the assignment of DASD datasets has been static. In this case, when multiple applications that execute at the same time access different DASD datasets on a common PV, optimal operation of the multiple applications may not be realized.

A system catalog describes dataset attributes and indicates storage volumes on which a dataset is located. When a dataset is cataloged, it can be referred to by name without a user specifying where the dataset is stored. Usually, datasets can be cataloged, uncataloged, or recataloged. In general, system-managed DASD datasets are cataloged automatically. In a storage operating system (OS) such as z/OS®, a master catalog and typically multiple user catalogs store locations of datasets. To locate a requested dataset, z/OS® typically requires three pieces of information: a dataset name (dsn); a volume name; and a unit (e.g., a volume device type, such as a 3390 disk or 3590 tape). In general, the three pieces of information may be specified by a user (such as a system administrator) using interactive system productivity facility (ISPF) panels or in a job control language (JCL). As is known, ISPF is a dialog manager for interactive applications that provides control and services to permit execution of dialogs. As is also known, JCL is sequence of commands used to identify a job to an operating system and to describe requirements of a job.

In general, a system catalog can provide a unit device type and volume name for any dataset that is cataloged. In this manner, a system catalog can be thought of as providing a simple look-up function that only requires a user to provide a dataset name. A storage OS usually has one master catalog and numerous user catalogs that are connected to the master catalog. A user catalog stores the dataset name and location of a dataset (dsn/volume/unit). The master catalog usually stores only a dataset high-level qualifier (HLQ) or alias with the name of the user catalog, which contains the location of all datasets prefixed by the HLQ.

With reference to FIG. 1, an example system catalog 100 includes a master catalog 102 and user catalogs 104 and 108. As is shown, the master catalog 102 points to the user catalogs 104 and 108 and a DASD 112. The user catalog 104 points to a DASD 106 and the DASD 112 and the user catalog 108 points to a DSAD 110 and the DASD 112. As is shown in FIG. 1, the master catalog 102 has a dataset name SYSTEM.MASTER.CATALOG. The master catalog 102 stores a full dataset name and location of all datasets with a SYS.A1 prefix. As is illustrated, the master catalog 102 includes two HLQ or alias entries (i.e., BIGCOUSER and USER) that are currently defined. A statement used to define the alias BIGCOUSER includes a dataset name of a user catalog containing all fully qualified BIGCOUSER datasets with their respective locations. Similarly, a statement used to define the alias USER includes a dataset name of a user catalog containing all fully qualified USER datasets with their respective locations. As one example, when SYS1.A1 is requested, the master catalog returns the location information (i.e., volume (wrk001) and unit (3390)) to the requestor. As another example, when BIGCOUSER.A1 is requested, the master catalog 102 redirects the request to the user catalog 104 (named USERCAT.BIGCO), which returns the location information (i.e., volume (wrk001) and unit (3390)) to the requestor.

The user catalogs 104 and 108 may be defined with the following statements:
DEFINE ALIAS (NAME (BIGCOUSER) RELATE (USERCAT.BIGCO))
DEFINE ALIAS (NAME (USER) RELATE (USERCAT.COMPANY))
   The define statements are used to place BIGCOUSER and USER alias names in the master catalog 102 with the names of the user catalogs that will store the fully qualified dataset names and location information. If BIGCOUSER.A1 is cataloged, a JCL statement to allocate BIGCOUSER.A1 to a job may be given by:
//INPUT DD DSN=BIGCOUSER.A1,DISP=SHR
   If BIGCOUSER.A1 is not cataloged, a JCL statement to allocate BIGCOUSER.A1 to a job may be given by:
//INPUT DD DSN=BIGCOUSER.A1,DISP=SHR,VOL=SER=WRK001 ,UNIT=3390
   As a general rule, all user datasets in a z/OS® installation are cataloged. Uncataloged datasets are rarely needed and their use is often related to recovery problems or installation of new software. Typically, when a user catalog becomes full or otherwise unavailable, the user catalog has required reorganization before associated datasets can be accessed. Unfortunately, during reorganization of a user catalog, datasets associated with the user catalog are not accessible.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of an example conventional system catalog for a storage system.

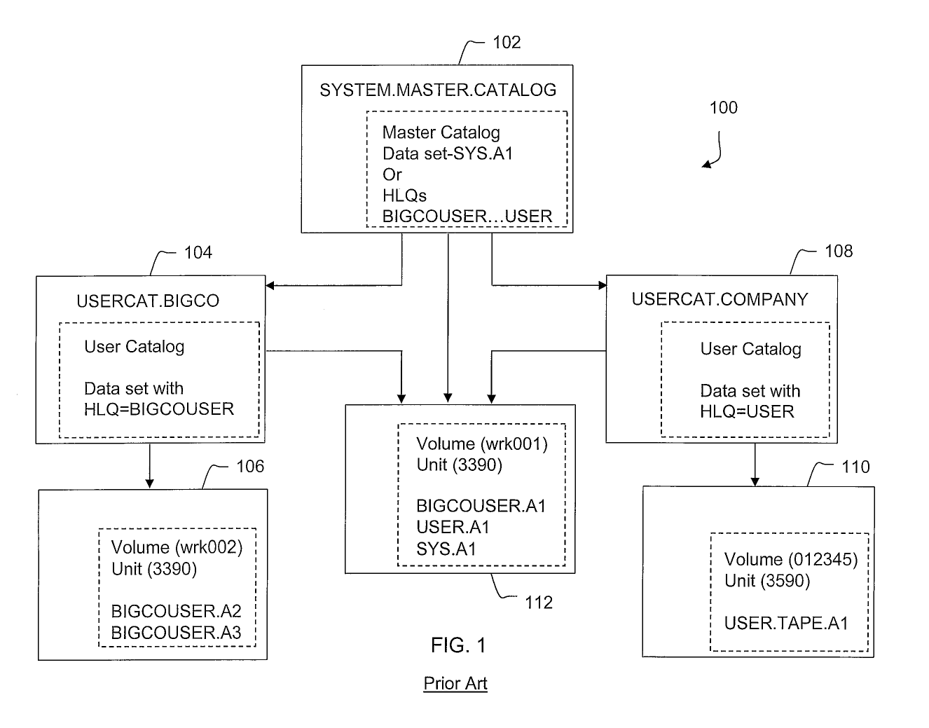

FIG. 2 is a block diagram of an example storage system that may employ dynamic creation of user catalogs, according to various embodiments of the present disclosure.

FIG. 3 is a flowchart of an example process for dynamically creating user catalogs for a storage system, according to various embodiments of the present disclosure.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, the present invention may take the form of a computer program product on a computer-usable storage medium having computer-usable program code embodied in the medium.

Any suitable computer-usable or computer-readable storage medium may be utilized. The computer-usable or computer-readable storage medium may be, for example, but is not limited to, an electronic, magnetic, optical, electromagnetic, infrared, or semiconductor system, apparatus, or device. More specific examples (a non-exhaustive list) of the computer-readable storage medium include the following: a portable computer diskette, a hard disk, a random access memory (RAM), a read-only memory (ROM), an erasable programmable read-only memory (EPROM) or Flash memory, a portable compact disc read-only memory (CD-ROM), an optical storage device, or a magnetic storage device. The computer-usable or computer-readable storage medium can even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable storage medium may be any medium that can contain or store the program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. The program code may execute entirely on a single computer, on multiple computers that may be remote from each other, or as a stand-alone software package. When multiple computers are employed, one computer may be connected to another computer through a local area network (LAN) or a wide area network (WAN), or the connection may be, for example, through the Internet using an Internet service provider (ISP).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, implement the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. As used herein, the term “coupled” includes both a direct electrical connection between blocks or components and an indirect electrical connection between blocks or components achieved using one or more intervening blocks or components.

According to various aspects of the present disclosure, a technique for handling a user catalog error condition (e.g., a user catalog full and/or a user catalog unavailable error condition) is disclosed that dynamically creates a new user catalog (based on the user catalog error condition) and updates alias entries in a master catalog to point to the new user catalog. In this manner, dataset creation is not interrupted when a user catalog is not available. This allows a user (e.g., a system administrator) of a data storage system to redefine and reorganize a user catalog at a later point in time (e.g., when the user catalog is not being accessed for storage or retrieval of a dataset). In general, the disclosed techniques intercept and interpret typical catalog full/catalog unavailable conditions (e.g., return and reason codes from catalog services) and instead of failing an associated define, a new user catalog is dynamically created and alias entries in a master catalog are updated to point to the new user catalog.

A new alias may, for example, be based on a dataset name define statement that is being processed when an error occurs. For example, the new alias may be based on an original alias and an additional qualifier that is based on the dataset name. In this manner, future locates initially search the new user catalog. As such, defines of new datasets and location of old datasets are transparent to a user of the storage system. According to another aspect of the present disclosure, the new user catalog is automatically reconciled with an original user catalog (when the original user catalog is redefined or reorganized). For example, deletions and redefines of the system catalog may be monitored and a system administrator may be prompted to reconcile catalog entries and return alias structures to their original state.

According to one aspect of the present disclosure, a technique for operating a storage system includes determining, based on a response (e.g., return and reason codes from catalog services) from a storage operating system, that a desired user catalog is unavailable for storage of a new dataset. A new user catalog is then dynamically created, when the desired user catalog is unavailable. An alias entry in a master catalog is then updated to point to the new user catalog, when the desired user catalog is unavailable.

According to another aspect of the present disclosure, a storage system is disclosed that includes multiple direct access storage devices and a processor coupled to the direct access storage devices. The processor is configured to determine, based on a response (e.g., return and reason codes from catalog services) from a storage operating system, that a desired user catalog is unavailable for storage of a new dataset. The processor is also configured to dynamically create a new user catalog and update an alias entry in a master catalog to point to the new user catalog, when the desired user catalog is unavailable.

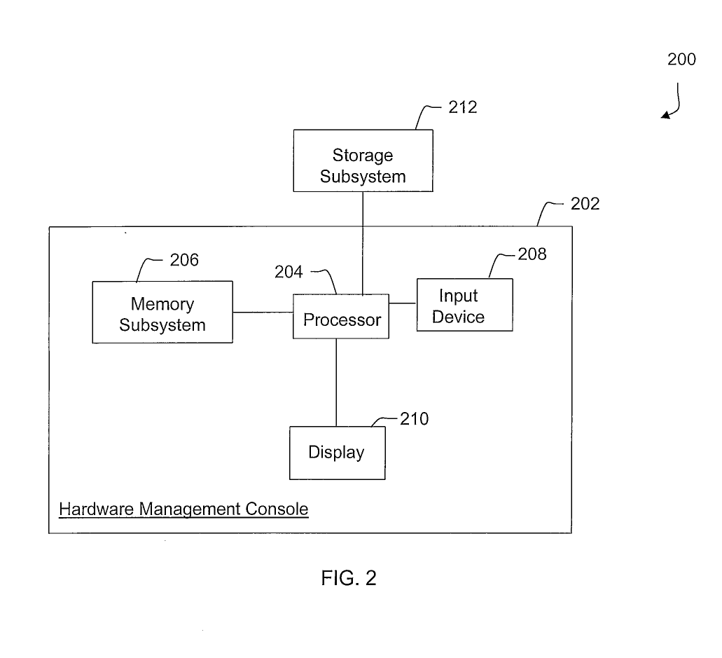

With reference to FIG. 2, an example storage system 200 (e.g., a DS8000 series storage system manufactured and made commercially available by IBM Corp.) is illustrated that may be configured to dynamically create user catalogs according to the present disclosure. As is shown, the system 200 includes a hardware management console (HMC) 202 that is coupled to a storage subsystem (product) 212. A dynamic user catalog creation application may be locally stored on the HMC (computer system) 202 or stored on a different computer system (e.g., a computer system that is included as part of the storage subsystem 212). The storage subsystem 212 may include, for example, multiple servers, and multiple direct access storage devices (DASDs), e.g., hard disk drives (HDDs) arranged in a redundant array of inexpensive disks (RAID) configuration.

As is illustrated, the HMC 202 includes a processor 204 (including one or more central processing units (CPUs)) that is coupled to the memory subsystem 206 (which includes an application appropriate amount of volatile and non-volatile memory), an input device 208 (e.g., a keyboard and a mouse), and a display 210 (e.g., a cathode ray tube (CRT) or a liquid crystal display (LCD)). The HMC 202 may be utilized, for example, by an administrator that is attempting to setup, maintain, or troubleshoot operation of the storage subsystem 212. The processor 204 of the HMC 202 is in communication with the storage subsystem 212 and may receive input from an administrator via, for example, a command line interface (CLI) provided via the display 210. Alternatively, the management console may be incorporated within the storage subsystem 212 or within another system or subsystem.

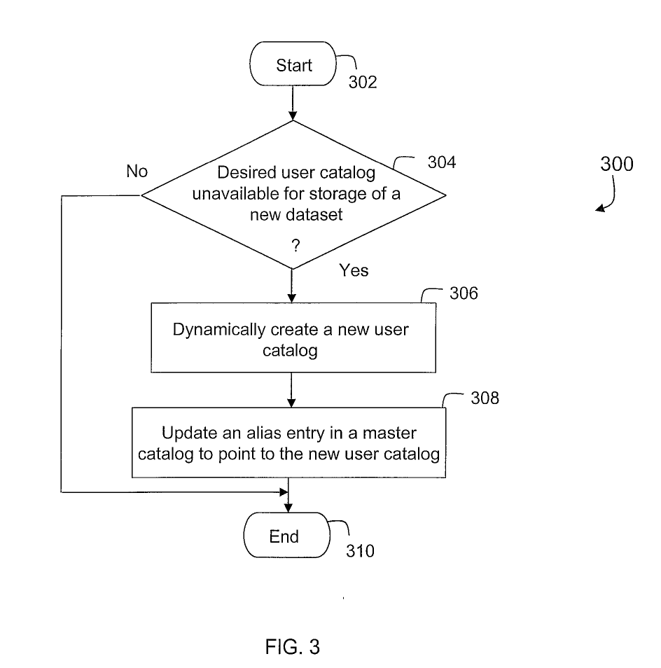

Moving to FIG. 3, an example process 300 for operating the storage system 200, is illustrated. In block 302, the process 300 is initiated at which point control transfers to block 304. In decision block 304, the processor 204 executes code for determining that a desired user catalog is unavailable for storage of a new dataset. The determination may be based on interception of a response (e.g., return and reason codes from catalog services) that indicates that the desired user catalog is unavailable because the desired user catalog is full or an associated DASD is offline, etc.

The processor 204 may evaluate all responses or a selected class of storage volume related responses (from the storage subsystem 212) to determine when the desired user catalog is unavailable. The storage volumes may correspond to physical volumes, logical volumes, or both physical and logical volumes. If the desired user catalog is available, control transfers from block 304 to block 310. If the desired user catalog is not available, control transfers from block 304 to block 306. In block 306, the processor 204 dynamically creates a new user catalog. Then, in block 308, the processor 204 causes an alias entry in a master catalog to be updated to point to the new user catalog. This facilitates storing the new dataset in a DASD associated with the new user catalog. For example, a new alias may be chosen for the new user catalog based, at least in part, on a dataset name associated with the desired user catalog. Following block 308, control transfers to block 310 where the process 300 returns to a calling process. According to another aspect of the present disclosure, the processor 204 may be configured to determine when the master catalog is being reorganized and notify an operating system of the storage system that the new user catalog requires reconciliation with the desired user catalog.

Accordingly, techniques have been disclosed herein that generally improve storage system operation in that dynamic creation of a new user catalog to store a dataset does not require manual intervention by a user (e.g., a system administrator) of the storage system.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of operating a storage system, comprising:
determining, based on a response from a storage operating system, that a desired user catalog is unavailable for storage of a new dataset;
dynamically creating a new user catalog when the desired user catalog is unavailable; and
updating an alias entry in a master catalog to point to the new user catalog when the desired user catalog is unavailable.

2. The method of claim 1, wherein the determining further comprises:
determining, based on the response from the storage operating system, that the desired user catalog is unavailable because the desired user catalog is full or an associated direct access storage device is offline.

3. The method of claim 1, wherein the updating further comprises;
choosing a new alias for the new user catalog based, at least in part, on a dataset name associated with the desired user catalog; and
creating the new alias in the alias entry of the master catalog that points to the new user catalog.

4. The method of claim 1, further comprising:
determining whether the master catalog is to be reorganized; and
notifying the storage operating system that the new user catalog requires reconciliation with the desired user catalog when the master catalog is to be reorganized.

5. The method of claim 1, further comprising:
storing the new dataset in a direct access storage device associated with the new user catalog.

6. A storage system, comprising:
multiple direct access storage devices; and
a processor coupled to the multiple direct access storage devices, wherein the processor is configured to:
determine, based on a response from a storage operating system, that a desired user catalog is unavailable for storage of a new dataset;
dynamically create a new user catalog when the desired user catalog is unavailable; and
update an alias entry in a master catalog to point to the new user catalog when the desired user catalog is unavailable.

7. The storage system of claim 6, wherein the processor is further configured to:
determine, based on the response from the storage operating system, that the desired user catalog is unavailable because the desired user catalog is full or an associated one of the multiple direct access storage devices is offline.

8. The storage system of claim 6, wherein the processor is further configured to;
choose a new alias for the new user catalog based, at least in part, on a dataset name associated with the desired user catalog; and
create the new alias in the alias entry of the master catalog that points to the new user catalog.

9. The storage system of claim 6, wherein the processor is further configured to:
determine when the master catalog is to be reorganized; and
notify the storage operating system that the new user catalog requires reconciliation with the desired user catalog when the master catalog is to be reorganized.

10. The storage system of claim 6, further comprising:
storing the new dataset in one of the multiple direct access storage devices that is associated with the new user catalog.
